(19) United States
(12) Patent Application Publication
(10) Pub. No.: US 2025/0249865 A1
(43) Pub. Date: Aug. 7, 2025

(54) CATALYTIC CONVERTER SHIELD ASSEMBLIES AND VEHICLES INCLUDING THE SAME

(71) Applicant: Toyota Motor Engineering & Manufacturing North America, Inc., Plano, TX (US)

(72) Inventors: Todd Rupert Muck, Fowlerville, MI (US); Ryan C. Harris, Saline, MI (US); Jeffery M. Nelson, Imlay City, MI (US); John Louis Miklas, Clinton Township, MI (US); Joseph J. Swailes, Oxford, MI (US)

(73) Assignees: Toyota Motor Engineering & Manufacturing North America, Inc., Plano, TX (US); Toyota Jidosha Kabushiki Kaisha, Toyota-shi (JP); Century Plastics, LLC d/b/a CIE USA, Shelby Township, MI (US)

(21) Appl. No.: 18/432,470

(22) Filed: Feb. 5, 2024

(51) Int. Cl. B60R 25/34; B60R 25/10

(52) U.S. Cl. CPC B60R 25/34; B60R 25/1004

(57) ABSTRACT

A catalytic converter shield assembly including a catalytic converter shield and vehicles including the catalytic converter shield assembly. The catalytic converter shield includes a first panel having an inner surface and an opposite outer surface, a second panel having an inner surface facing the first panel and an opposite outer surface, a wire array provided between the first panel and the second panel, and a heat shielding layer provided on the outer surface of the second panel opposite the wire array.

### TECHNICAL FIELD

The present specification generally relates to catalytic converter shields for preventing theft of a catalytic converter and, more specifically, vehicles including catalytic converter shield assemblies mounted to an underside of the vehicle.

### BACKGROUND

Catalytic converters for vehicles contain precious rare metals such as, for example, platinum, rhodium, and palladium. The value of these rare metals have increased in recent years. Accordingly, as the value of these metals increases, theft of catalytic converters has become more common in the automotive industry. Available solutions to prevent theft of catalytic converters on vehicles are typically heavy and bulky, and fail to sufficiently deter theft activity of catalytic converters.

Accordingly, a need exists for improved protection devices for preventing theft of catalytic converters mounted onto a vehicle.

### SUMMARY

In one embodiment, a catalytic converter shield assembly includes: a catalytic converter shield including: a first panel having an inner surface and an opposite outer surface; a second panel having an inner surface facing the first panel and an opposite outer surface; a wire array provided between the first panel and the second panel; and a heat shielding layer provided on the outer surface of the second panel opposite the wire array.

In another embodiment, a vehicle includes: a chassis; an exhaust pipe having an upstream portion and an opposite downstream portion; a catalytic converter interposed between the upstream portion and the downstream portion of the exhaust pipe; and a catalytic converter shield assembly coupled to the chassis, the catalytic converter including: a catalytic converter shield provided on a side of the catalytic converter opposite the chassis, the catalytic converter shield including: a first panel having an inner surface and an opposite outer surface; a second panel having an inner surface facing the first panel and an opposite outer surface; a wire array provided between the first panel and the second panel; and a heat shielding layer provided on the outer surface of the second panel opposite the wire array.

In yet another embodiment, a method includes: positioning a wire array between a first spray transfer molded panel and a second spray transfer molded panel; positioning a heat shield layer to an outer surface of the second spray transfer molded panel opposite the first spray transfer molded panel; and molding the first spray transfer molded panel, the wire array, the second spray transfer molded panel, and the heat shield layer to form a catalytic converter shield.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a bottom view of a vehicle including a catalytic converter shield, according to one or more embodiments shown and described herein;

FIG. 2 schematically depicts a cross-sectional side view of the catalytic converter shield mounted to a chassis of the vehicle taken along line 2-2 of FIG. 1, according to one or more embodiments shown and described herein;

FIG. 3 schematically depicts a top perspective view of the catalytic converter shield, according to one or more embodiments shown and described herein;

FIG. 4 schematically depicts a cross-sectional side view of a mounting pocket of the catalytic converter shield taken along line 4-4 of FIG. 3 and the catalytic converter shield mounted to the chassis of the vehicle, according to one or more embodiments shown and described herein;

FIG. 5 schematically depicts a cross-sectional side view of a mounting clip of the catalytic converter shield taken along line 5-5 of FIG. 3 and the catalytic converter shield mounted to the chassis of the vehicle, according to one or more embodiments shown and described herein;

FIG. 6 schematically depicts a cross-sectional side view of the catalytic converter shield taken along line 6-6 of FIG. 3 being formed between an upper die and a lower die, according to one or more embodiments shown and described herein;

FIG. 7 schematically depicts a cross-sectional side view of another embodiment of a catalytic converter shield including a substrate layer and being formed between an upper die and a lower die, according to one or more embodiments shown and described herein; and

FIG. 8 schematically depicts a top plan view of the catalytic converter shield of FIG. 6 including an electrical wire being electrically coupled to an alarm device of the vehicle, according to one or more embodiments shown and described herein.

### DETAILED DESCRIPTION

Embodiments described herein are directed to a catalytic converter shield for protecting a catalytic converter on a vehicle from theft activity. The catalytic converter shield includes a first panel having an inner surface and an opposite outer surface, a second panel having an inner surface facing the first panel and an opposite outer surface, a wire array provided between the first panel and the second panel, and a heat shielding layer provided on the outer surface of the first panel opposite the wire array. The wire array may include one or more tensile wires to increase difficulty and noise while cutting through the catalytic converter shield and/or one or more electrical wires in electrical communication with a sensor to detect when the catalytic converter shield is being cut. In response to the sensor detecting that the electrical wires have been cut, the sensor sends a signal to an alarm device of the vehicle to initiate an audible and/or visual alarm event to deter the theft activity. Various embodiments of the catalytic converter shield, catalytic converter shield assemblies, and the methods of forming the catalytic converter shield are described in more detail herein. Whenever possible, the same reference numerals will be used throughout the drawings to refer to the same or like parts.

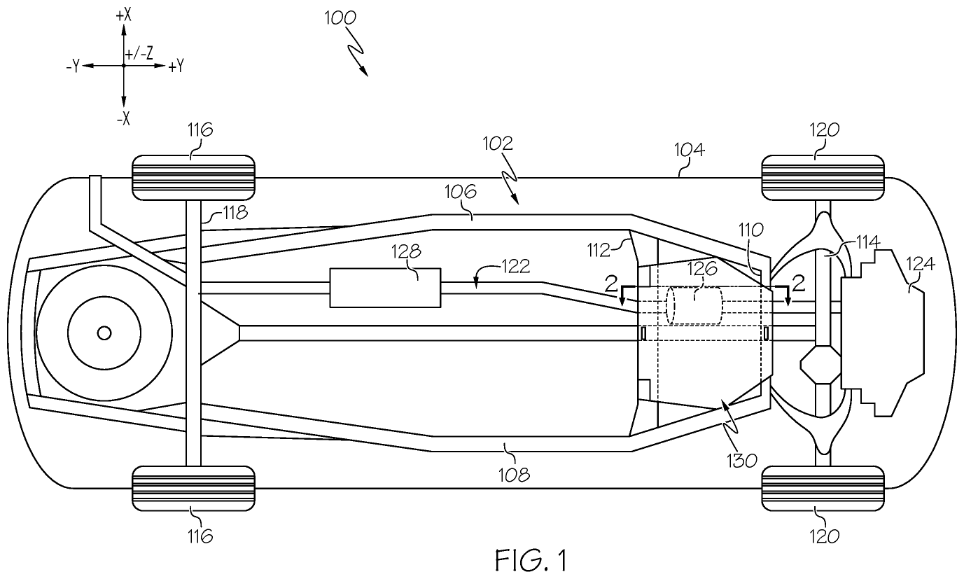

As used herein, the term “vehicle longitudinal direction” refers to the forward-rearward direction of the vehicle (i.e., in the +/−Y direction of the coordinate axes depicted in FIG. 1). The term “vehicle lateral direction” refers to the cross-vehicle direction (i.e., in the +/−X direction of the coordinate axes depicted in FIG. 1), and is transverse to the vehicle longitudinal direction. The term “vehicle vertical direction” refers to the upward-downward direction of the vehicle (i.e., in the +/−Z direction of the coordinate axes depicted in FIG. 1). As used herein, “upper” and “above” are defined as the positive Z direction of the coordinate axes shown in the drawings. “Lower” and “below” are defined as the negative Z direction of the coordinate axes shown in the drawings.

Referring now to FIG. 1, a bottom view of a vehicle 100 is illustrated according to one or more embodiments described herein. The vehicle 100 may generally include a chassis 102 and a body 104 mounted on the chassis 102. The chassis 102 includes a first side rail 106 and a second side rail 108 extending in the vehicle longitudinal direction. The chassis 102 further includes a front crossmember 110 and a center crossmember 112 positioned rearward of the front crossmember 110 in the vehicle longitudinal direction. The front crossmember 110 and the center crossmember 112 each extend in the vehicle lateral direction between the first side rail 106 and the second side rail 108. A front wheel axle 114 is provided in front of the front crossmember 110 in the vehicle longitudinal direction.

The vehicle 100 further includes a pair of rear wheels 116 provided on opposite sides of a rear wheel axle 118, a pair of front wheels 120 provided on opposite sides of the front wheel axle 114, and an exhaust pipe 122 generally extending in the vehicle longitudinal direction from an engine 124. One or more catalytic converters 126 may be positioned within the exhaust pipe 122 upstream of a muffler 128 to minimize harmful substances in the exhaust gases created within the engine 124 of the vehicle 100. As shown in FIG. 1, the catalytic converter 126 is arranged in communication with the exhaust pipe 122 and positioned above a bottom surface of the chassis 102 in the vehicle vertical direction and between the front crossmember 110 and the center crossmember 112 in the vehicle longitudinal direction. Accordingly, as described in more detail herein, to restrict access to the catalytic converter 126 from below the vehicle 100 and prevent the catalytic converter 126 from being readily cut from the exhaust pipe 122 during theft activity, the vehicle 100 includes a catalytic converter shield 130 mounted to the chassis 102 of the vehicle 100 below the catalytic converter 126. As shown in FIG. 1, the catalytic converter shield 130 is mounted at a front end thereof to the front crossmember 110 and at an opposite rear end thereof to the center crossmember 112. In embodiments, the catalytic converter shield 130 may also be mounted to the first side rail 106 and the second side rail 108 at respective sides of the catalytic converter shield 130.

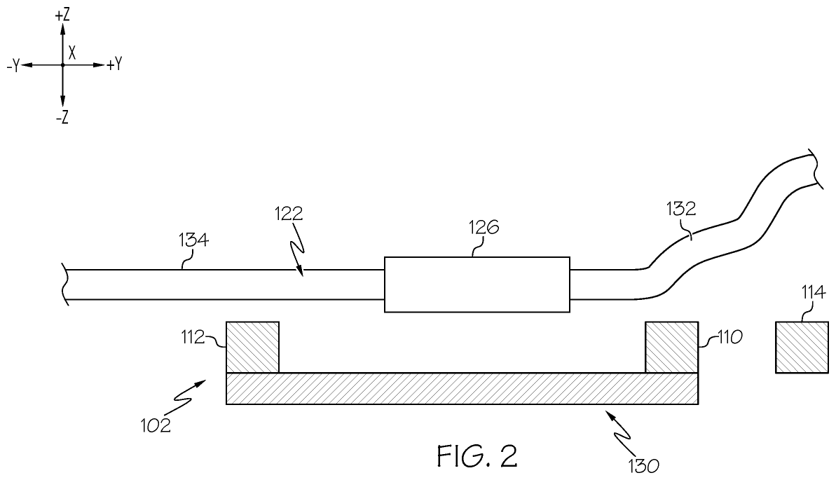

Referring now to FIG. 2, a partial cross-sectional view of the vehicle 100 is illustrated with the catalytic converter shield 130 mounted below the catalytic converter 126. Specifically, as described herein, the catalytic converter shield 130 is mounted to the front crossmember 110 and the center crossmember 112 below the catalytic converter 126 to prevent direct access to the catalytic converter 126 from under the vehicle 100. Conventionally, when a catalytic converter protection device such as, for example, a cage or shield, is utilized to prevent direct access to a catalytic converter, a reciprocating saw or other suitable cutting tool may be used to cut opposite accessible portions of an exhaust pipe to allow the catalytic converter provided between the opposite cut portions to drop from the chassis of the vehicle. However, the present disclosure interferes with one's ability to cut portions of an exhaust pipe on opposite sides of a catalytic converter. Specifically, the exhaust pipe 122 is shown generally extending in the vehicle longitudinal direction with an upstream portion 132 extending in the vehicle vertical direction above and over the front wheel axle 114. Accordingly, even if one were to use a cutting tool such as, for example, a reciprocating saw, to cut a downstream portion 134 of the exhaust pipe 122, the reciprocating saw is generally not able to fit between the front crossmember 110 and the front wheel axle 114 to cut the upstream portion 132 of the exhaust pipe 122. As such, the only other way to access the catalytic converter 126 is to cut directly through the catalytic converter shield 130. However, as described herein, the catalytic converter shield 130 includes one or more mechanisms for deterring cutting through the catalytic converter shield 130.

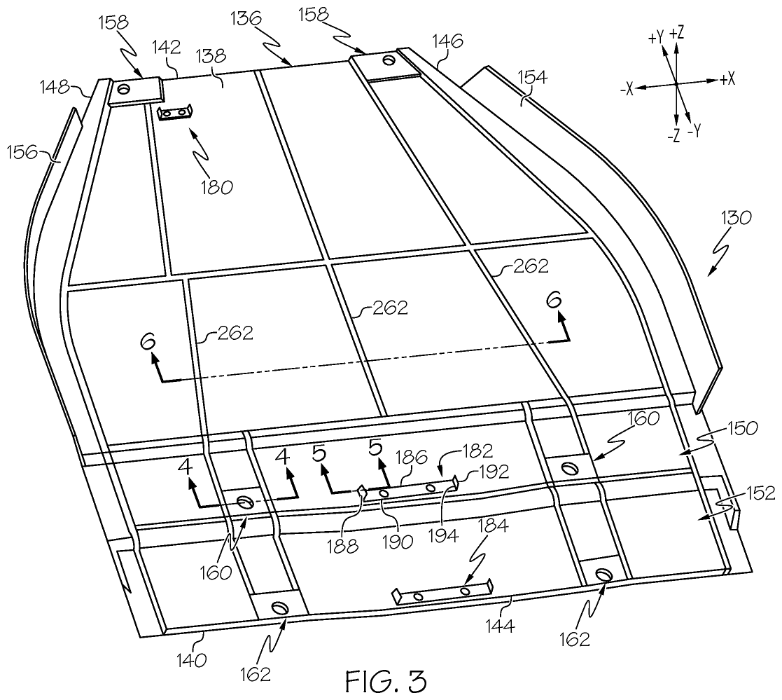

Referring now to FIG. 3, a top perspective view of the catalytic converter shield 130 separate from the chassis 102 of the vehicle 100. The catalytic converter shield 130 generally includes a body panel 136 having an upper surface 138, a lower surface 140 opposite the upper surface 138, a front end 142, a rear end 144 opposite the front end 142, a first side edge 146, and a second side edge 148 opposite the first side edge 146. The first side edge 146 and the second side edge 148 each extend between the front end 142 and the rear end 144 of the body panel 136. It should be appreciated that the upper surface 138 of the body panel 136 faces the catalytic converter 126 when the catalytic converter shield 130 is mounted onto the chassis 102 of the vehicle 100 (FIG. 1).

In embodiments, the body panel 136 is a substantially planar member. However, in other embodiments, the body panel 136 includes one or more steps formed therein to accommodate the center crossmember 112 (FIG. 1) being positioned lower relative to the front crossmember 110 (FIG. 1) in the vehicle vertical direction. As shown in FIG. 3, the body panel 136 includes a first step portion 150 formed therein and recessed in a direction toward the lower surface 140 of the body panel 136. Additionally, it should be appreciated that an additional step portion may be formed in the body panel 136 to accommodate different vertical and longitudinal positions of the center crossmember 112 relative to the front crossmember 110. For example, a center crossmember of a hybrid vehicle or a fully electric vehicle may be positioned lower relative to a front crossmember of the vehicle to accommodate additional space requirements in the floor of the vehicle for housing a battery, as compared to a position of a center crossmember of a non-electric vehicle. Therefore, in embodiments, the body panel 136 includes the first step portion 150 and a second step portion 152 formed rearward of the first step portion 150 in the vehicle longitudinal direction. The second step portion 152 is recessed further in a direction toward the lower surface 140 of the body panel 136 than the first step portion 150.

In embodiments, a first side wall 154 extends from upper surface 138 of the body panel 136 at the first side edge 146 in a direction opposite the lower surface 140 of the body panel 136. Additionally, a second side wall 156 extends from the upper surface 138 of the body panel 136 at the second side edge 148 in a direction opposite the lower surface 140 of the body panel 136. The first side wall 154 and the second side wall 156 each extend generally perpendicular to the body panel 136. In embodiments, the first side wall 154 and the second side wall 156 extend an entire length along the first side edge 146 and the second side edge 148, respectively, between the front end 142 and the rear end 144 of the body panel 136. In other embodiments, as shown, the first side wall 154 and the second side wall 156 extend a substantial length along the first side edge 146 and the second side edge 148, respectively, between the front end 142 and the rear end 144 of the body panel 136.

In embodiments, a plurality of mounting pockets and/or a plurality of mounting clips may be utilized to secure the catalytic converter shield 130 to the chassis 102 of the vehicle 100. As shown in FIG. 3, the catalytic converter shield 130 includes a first pair of mounting pockets 158 provided at the front end 142 of the body panel 136. In embodiments, the catalytic converter shield 130 further includes a second pair of mounting pockets 160 formed in the first step portion 150 and a third pair of mounting pockets 162 formed in the second step portion 152. However, it should be appreciated that the catalytic converter shield 130 may include any number of mounting pockets apart from that specifically depicted herein. Each of the mounting pockets 158, 160, 162 have identical structure and, thus, only the structure of one of the mounting pockets 160 will be described in detail herein.

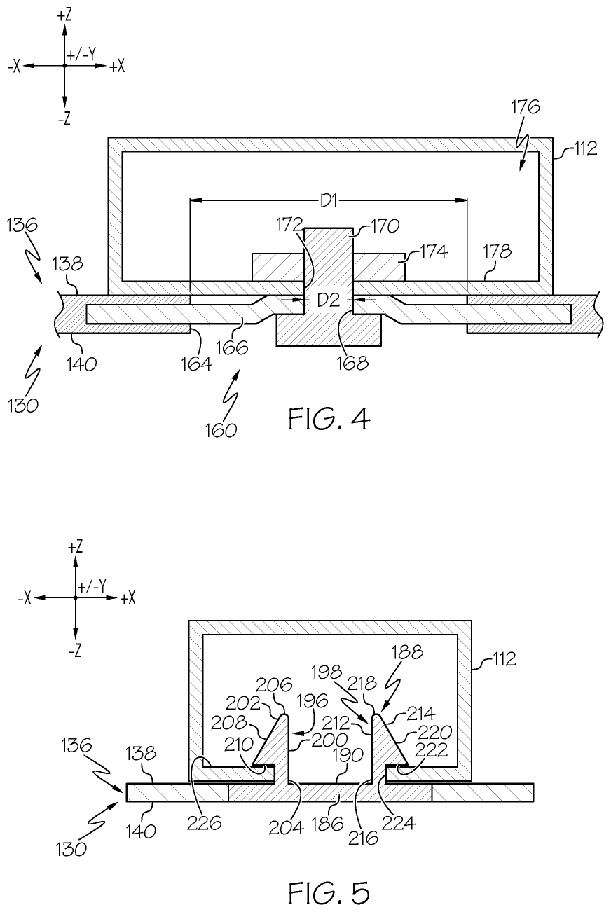

Referring now to FIG. 4, the mounting pocket 160 defines a pocket opening 164 formed in the body panel 136 having a pocket opening diameter D1. The mounting pocket 160 includes a reinforcing plate 166 extending across the pocket opening 164. As such, the reinforcing plate 166 surrounds the pocket opening 164. The reinforcing plate 166 may be secured to the body panel 136 in any suitable manner. For example, the reinforcing plate 166 may be welded or otherwise secured to the upper surface 138 or the lower surface 140 of the body panel 136. In other embodiments, as described in more detail herein, the body panel 136 may be formed by a spray transfer molding or in any other suitable manner such that the reinforcing plate 166 is formed within the body panel 136 itself. The reinforcing plate 166 defines a plate opening 168 having a plate opening diameter D2 less than the pocket opening diameter D1. In embodiments, the reinforcing plate 166 is formed from any suitable material such as, for example, steel, plastic, aluminum, nickel, titanium, or the like, or a combination thereof.

To secure the catalytic converter shield 130 to the chassis 102 of the vehicle 100, such as to the front crossmember 110 and the center crossmember 112, a fastener, such as a rivet, bolt, screw, or the like, extends through the plate opening 168 formed in the mounting pocket 160 and into the chassis 102. For example, as shown in FIG. 4 with respect to the mounting pocket 160 of the body panel 136, a fastener 170 extends through the plate opening 168 and into the center crossmember 112. The fastener 170 further extends through an opening 172 formed in the center crossmember 112. In embodiments in which the fastener 170 is a bolt, a nut 174 may be provided within an interior 176 of the center crossmember 112 to threadedly engage the fastener 170 and secure the catalytic converter shield 130 to the center crossmember 112. The nut 174 may be fixed to an inner surface 178 of the center crossmember 112 to threadedly engage the fastener 170 as the fastener 170 is rotated and extends into the interior 176 of the center crossmember 112. In some embodiments, the nut 174 may be a threaded rivet nut or a weld nut.

As described herein, the mounting pockets 158, 160, 162 have identical structure. Thus, it should be appreciated that the catalytic converter shield 130 may be further secured to the front crossmember 110 and the center crossmember 112, as well as any other portion of the chassis 102, in the manner described above with respect to the other mounting pockets 158, 162. However, based upon the location of the center crossmember 112, which depends on the type of the vehicle (hybrid, full electric, or non-electric vehicle) to which the catalytic converter shield 130 is secured, the catalytic converter shield 130 may be secured to the center crossmember 112 at either the second pair of mounting pockets 160 or the third pair of mounting pockets 162.

Referring again to FIG. 3, in embodiments, a plurality of mounting clips are provided on the upper surface 138 of the body panel 136 and spaced apart from the mounting pockets 158, 160, 162 to further facilitate securing the catalytic converter shield 130 to the chassis 102. For example, in embodiments, the plurality of mounting clips include a first mounting clip 180 a second mounting clip 182, and a third mounting clip 184. The first mounting clip 180 is provided on the upper surface 138 of the body panel 136 proximate the front end 142 of the body panel 136. The second mounting clip 182 is provided on the upper surface 138 of the body panel 136 on the first step portion 150. The third mounting clip 184 is provided on the upper surface 138 of the body panel 136 on the second step portion 152.

The mounting clips 180, 182, 184 may be secured to the body panel 136 in any suitable manner. For example, the mounting clips 180, 182, 184 may be welded or otherwise secured to the upper surface 138 of the body panel 136. In other embodiments, as described above with respect to the manner of attaching the reinforcing plate 166, and described in more detail herein, the body panel 136 may be formed by a spray transfer molding or in any other suitable manner such that the mounting clips 180, 182, 184 are formed within the body panel 136 itself. Additionally, the mounting clips 180, 182, 184 may be provided at any suitable location on the body panel 136. For example, the mounting clip 182 provided within the first step portion 150 may be positioned at a substantially center position of the body panel 136 in the vehicle lateral direction between the mounting pockets 160 formed in the first step portion 150. In other embodiments, a plurality of mounting clips 182 may be provided within the first step portion 150. In such embodiments, the mounting clips 182 may be provided on one or both sides of either or both of the mounting pockets 160. The same is applicable to the number and position of the mounting clips 180, 184.

Each of the mounting clips 180, 182, 184 have identical structure and, thus, only the mounting clip 182 provided within the first step portion 150 is described in detail herein. Referring still to FIG. 3, the mounting clip 182 may be a substantially U-shaped member secured to the body panel 136. In embodiments, the mounting clip 182 includes a base 186, a first engaging portion 188 provided at a first end 190 of the base 186, and a second engaging portion 192 provided at a second end 194 of the base 186 opposite the first end 190.

Referring now to FIG. 5, the first engaging portion 188 of the mounting clip 182 is shown engaging the center crossmember 112. In embodiments, the mounting clip 182 is a resin temperature set clip. However, it should be appreciated that any suitable clip may be utilized. Additionally, as shown in FIG. 5, the base 186 of the mounting clip 182 is at least partially encapsulated in the body panel 136 while the first engaging portion 188, as well as the second engaging portion 192 (FIG. 3), extend from the body panel 136 in a direction opposite the lower surface 140 of the body panel 136. In embodiments, the first engaging portion 188 and the second engaging portion 192 are identical to one another. As such, only the first engaging portion 188 is described in detail herein.

The first engaging portion 188 includes a first finger 196 and a second finger 198 each extending from the base 186. The first finger 196 has an inner surface 200, an outer surface 202 opposite the inner surface 200, a proximal end 204 at the base 186, and a distal end 206 opposite the proximal end 204. A lip 208 is formed at the distal end 206 of the first finger 196. The lip 208 has a thickness that increases in a direction toward the proximal end 204 and terminates to define an abutting surface 210. Similarly, the second finger 198 has an inner surface 212, which faces the inner surface 200 of the first finger 196, an outer surface 214 opposite the inner surface 212 of the second finger 198, a proximal end 216 at the base 186, and a distal end 218 opposite the proximal end 216. A lip 220 is formed at the distal end 218 of the second finger 198. The lip 220 has a thickness that increases in a direction toward the proximal end 216 and terminates to define an abutting surface 222. In embodiments, the first finger 196 and the second finger 198 have a degree of flexibility at the base 186. Accordingly, the distal end 206 of the first finger 196 and the distal end 218 of the second finger 198 may be brought closer to one another when an inwardly force is applied.

To secure the catalytic converter shield 130 to the chassis 102 of the vehicle 100, such as the front crossmember 110 or the center crossmember 112, the mounting clips 180, 182, 184 are inserted and retained within the chassis 102. For example, as shown in FIG. 5 with respect to the mounting clip 182, the first engaging portion 188, as well as the second engaging portion 192 (FIG. 3), and specifically the first finger 196 and the second finger 198, are inserted into the center crossmember 112 through an opening 224 formed in the center crossmember 112. With the first engaging portion 188 inserted into the center crossmember 112, a bottom wall 226 of the center crossmember 112 is positioned between the base 186 and the abutting surfaces 210, 222 of the first finger 196 and the second finger 198, respectively.

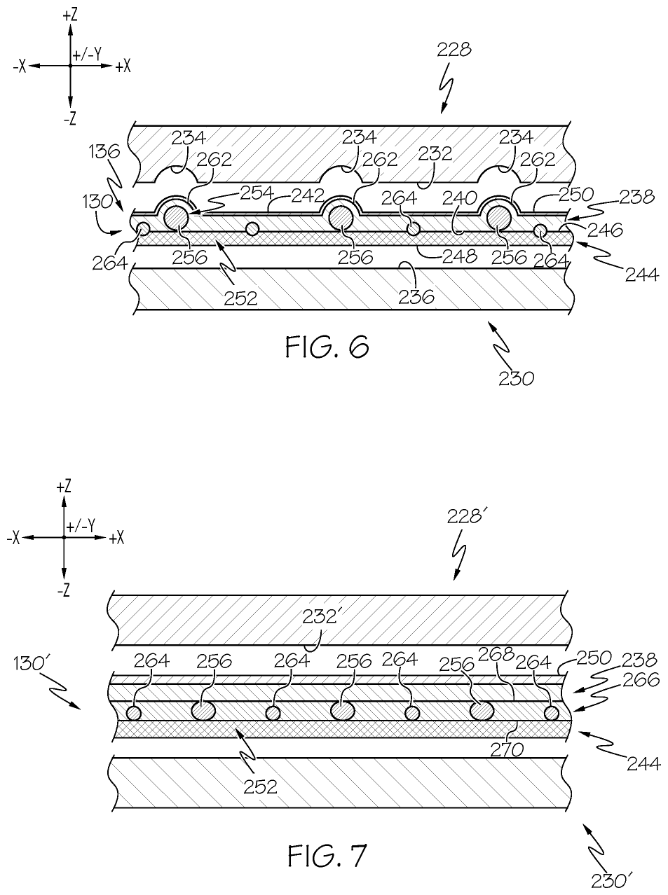

The catalytic converter shield 130 may be formed using any suitable manufacturing or molding technique such as, for example, spray transfer molding, resin transfer molding, injection molding, or the like. Accordingly, as shown in FIG. 6, a cross-sectional view of the catalytic converter shield 130 is depicted being formed between an upper die 228 and a lower die 230. In embodiments, the upper die 228 has an inner surface 232 defining a plurality of grooves 234, and the lower die 230 has a planar inner surface 236.

Referring still to FIG. 6, the body panel 136 of the catalytic converter shield 130 includes a first panel 238 having an inner surface 240 and an outer surface 242 opposite the inner surface 240, and a second panel 244 having an inner surface 246 and an outer surface 248 opposite the inner surface 246 of the second panel 244. In embodiments in which the catalytic converter shield 130 is formed by spray transfer molding, the first panel 238 and the second panel 244 may be formed from fiberglass. Accordingly, the first panel 238 and the second panel 244 may be referred to herein as a first spray transfer molded panel and a second spray transfer molded panel, respectively.

In embodiments, the catalytic converter shield 130 includes a heat shielding layer 250. To prevent or reduce the likelihood of heat damage to the catalytic converter shield 130, the heat shielding layer 250 is provided on a surface of the catalytic converter shield 130 facing the catalytic converter 126 (FIG. 1). Accordingly, as shown in FIG. 6, it should be appreciated that the first panel 238 is oriented to face the catalytic converter 126 and, thus, the heat shielding layer 250 is provided on the outer surface 242 of the first panel 238 opposite the second panel 244. However, the orientation of the catalytic converter shield 130 is not limited to that depicted herein. For example, the catalytic converter shield 130 may be oriented such that the second panel 244 faces the catalytic converter 126 and the heat shielding layer 250 is provided on the outer surface 248 of the second panel 244. The heat shielding layer 250 may be secured to the first panel 238 in any suitable manner such as, for example, bonded, welded, adhered, or the like.

One or more wire arrays 252 are provided between the first panel 238 and the second panel 244. In embodiments, the one or more wire arrays 252 includes a wire mesh 254 defining a plurality of tensile wires 256. The tensile wires 256 may be arranged in any suitable manner such as, for example, extending parallel to one another, interconnected to form a wire grid or the like. However, it should be appreciated that the one or more wire arrays 252 may include a plurality of individual tensile wires that are not connected to one another so as to not form a wire mesh. As such, the individual tensile wires may be arranged in any suitable arrangement such as, for example, parallel or non-parallel, overlapping or non-overlapping, and the like.

The tensile wires 256 may include high tensile wire, high carbon music wire, piano wire, steel wire, spring steel, and the like, or a combination thereof. In embodiments, the tensile wires 256 have a hardness equal to or greater than 500 megapascals (MPa) and less than or equal to 2,000 MPa. In embodiments, the tensile wires 256 have a hardness equal to or greater than 750 MPa and less than or equal to 1,750 MPa. In embodiments, the tensile wires 256 have a hardness equal to or greater than 1,000 MPa and less than or equal to 1,500 MPa. In embodiments, the tensile wires 256 have a hardness of 1,500 MPa+/−10%. In embodiments, the tensile wires 256 have a hardness of 1,500 MPa+/−20%. In embodiments, the tensile wires 256 have a hardness of 1,500 MPa+/−30%. The tensile wires 256 may have a diameter equal to or greater than 1 millimeter (mm) and less than or equal to 5 mm. The tensile wires 256 may have a diameter equal to or greater than 2 mm and less than or equal to 3 mm. The tensile wires 256 may have a diameter of 2.5 mm+/−10%. The tensile wires 256 may have a diameter of 2.5 mm+/−20%. The tensile wires 256 may have a diameter of 2.5 mm+/−30%.

The tensile wires 256 are provided to increase the difficulty in cutting through the catalytic converter shield 130 to access the catalytic converter 126 (FIG. 1). Specifically, cutting through the tensile wires 256 results in increased noise drawing attention to the potentially theft activity. Depending on the thickness and the tension of the tensile wires 256, cutting through a single tensile wire may take between 20 seconds and one minute, require between 100 Newtons (N) and 400 N of force, and create noise in excess of 100 decibels (Db).

As described herein, the first panel 238 and the second panel 244 are formed between the upper die 228 and the lower die 230 with the tensile wires 256 provided between the first panel 238 and the second panel 244. During compression of the first panel 238 and the second panel 244 between the upper die 228 and the lower die 230, the tensile wires 256 are received within respective grooves 234 formed in the inner surface 232 of the upper die 228. This allows reduced space between the tensile wires 256 and the first panel 238 as opposed to embodiments in which the grooves 234 are not formed in the upper die 228. This also keeps the tensile wires 256 in place during curing of the first panel 238 and the second panel 244. Accordingly, after the first panel 238 and the second panel 244 are compressed by the upper die 228 and the lower die 230, a plurality of protrusions 262 are formed within the first panel 238 and the heat shielding layer 250 at the individual tensile wires 256. As shown in FIG. 3, the protrusions 262 formed by the tensile wires 256 are depicted in the upper surface 138 of the body panel 136.

In embodiments, the one or more wire arrays 252 includes one or more electrical wires 264 provided between the first panel 238 and the second panel 244. The electrical wires 264 may be disposed between adjacent tensile wires 256. Although FIG. 6 depicts an embodiment in which the tensile wires 256 and the electrical wires 264 are both provided between the first panel 238 and the second panel 244, it should be appreciated that either the tensile wires 256 or the electrical wires 264 may be omitted. In other embodiments, it should be appreciated that the tensile wires 256 serve the function as the electrical wires 264, as described in more detail herein.

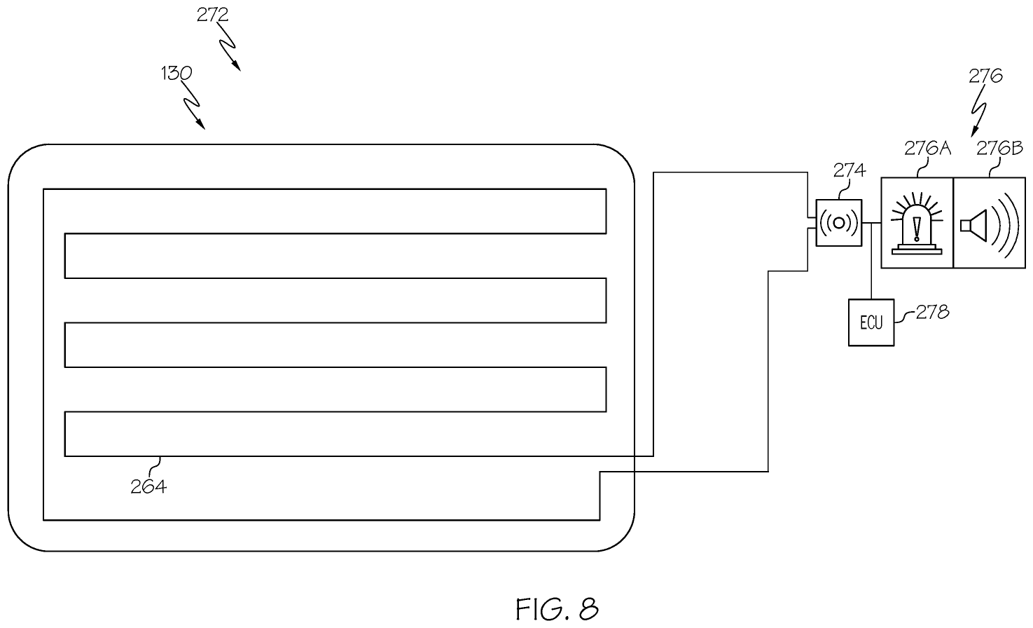

Referring now to FIG. 7, a cross-sectional view of another embodiment of a catalytic converter shield 130′ is depicted being formed between an upper die 228′ and a lower die 230′. It should be appreciated that the catalytic converter shield 130′ is similar to the catalytic converter shield 130 depicted in FIG. 6. As such, like reference numerals will be utilized to refer to like parts. Rather, than the tensile wires 256 and the electrical wires 264 being provided between and in contact with the first panel 238 and the second panel 244 and require the upper die 228′ to have grooves formed therein, as depicted in FIG. 6, the tensile wires 256 and the electrical wires 264 are provided within a substrate layer 266 between the first panel 238 and the second panel 244. In embodiments, the substrate layer 266 is formed from a corrugated material such as, for example, cardboard, a plastic, and the like, or a combination thereof.

The substrate layer 266 has a first surface 268 and a second surface 270 opposite the first surface 268. In embodiments, the substrate layer 266 has a thickness extending between the first surface 268 and the second surface 270 equal to or greater than 1 millimeter (mm) and less than or equal to 5 mm. In embodiments, the substrate layer 266 has a thickness equal to or greater than 2 mm and less than or equal to 3 mm. In embodiments, the substrate layer 266 has a thickness of 2.5 mm+/−10%. The substrate layer 266 has a thickness of 2.5 mm+/−20%. In embodiments, the substrate layer 266 has a thickness of 2.5 mm+/−30%.

The tensile wires 256 and the electrical wires 264 may be initially placed on the first surface 268 or the second surface 270 of the substrate layer 266 and, during compression of the first panel 238 and the second panel 244, the tensile wires 256 and the electrical wires 264 become embedded within the substrate layer 266. Accordingly, as shown in FIG. 7, the tensile wires 256 do not result in protrusions being formed in the first panel 238, as depicted in the catalytic converter shield 130 in FIG. 6. Thus, the upper die 228′ has a planar inner surface 232′ rather than the upper die 228 depicted in FIG. 6 including grooves 234 formed therein.

As shown in FIG. 8, a catalytic converter shield assembly 272 is depicted including the catalytic converter shield 130, a sensor 274, and an alarm device 276. Although the catalytic converter shield assembly 272 is described herein as including the catalytic converter shield 130 depicted in FIG. 6, it should be appreciated that the catalytic converter shield assembly 272 may instead include the catalytic converter shield 130′ without deviating from the scope of the present disclosure.

A cross-sectional view of the catalytic converter shield 130 is depicted in FIG. 8 including a single electrical wire 264 electrically coupled to the sensor 274. However, any number of electrical wires 264 may be provided and electrically coupled to the sensor 274. The sensor 274 is electrically coupled to the alarm device 276. The alarm device 276 may be an existing alarm device of the vehicle 100 or a separate alarm device to be attached to the vehicle 100 along with the catalytic converter shield 130. The alarm device 276 includes a light emitting device 276A and/or an audio emitting device 276B. The light emitting device 276A includes vehicle lights (e.g., headlights, tail lamps, interior lights, etc.) and/or an external light attached to the vehicle 100. The audio emitting device 276B includes speakers, a horn, and/or an external speaker attached to the vehicle 100. The sensor 274 may be electrically coupled to the alarm device 276 directly or indirectly such as by being electrically coupled or communicatively coupled to a controller, such as an electronic control unit (ECU) 278 that is electrically coupled or communicatively coupled to the sensor 274. In embodiments, the ECU 278 may detect or receive the signal output from the sensor 274. Upon detection or receipt of the signal output from the sensor 274, the ECU 278 may control the alarm device 276 to output the audible alarm and/or the visual alarm.

When the electrical wire 264, or any one of the plurality of electrical wires 264, are cut, the sensor 274 detects a discontinuity in the electrical wire(s) 264 and sends a signal to the alarm device 276 of the vehicle 100 to initiate an alarm event. The alarm event may be an audible alarm and/or a visual alarm. The alarm device 276 may include or be configured to control any number of components of the vehicle 100 to be activated during the alarm event such as, for example, a horn, lights, and the like. In embodiments, the alarm event may be initiated for a predetermined period of time, for example 1 minute, 2 minutes, 5 minutes, or more, after the sensor 274 detects that the electrical wire(s) 264 have been cut, or until manually deactivated such as by operating a wireless device communicating with the vehicle 100.

Although the tensile wires 256 and the electrical wires 264 are each depicted as separate wire arrays in the catalytic converter shield 130 illustrated in FIG. 6, as well as the catalytic converter shield 130′ illustrated in FIG. 7, it should be appreciated that the catalytic converter shield 130 may include only single wire array such as, for example, the tensile wires 256, which may be electrically coupled to the sensor 274 and the alarm device 276. As such, the tensile wires 256 may serve dual purposes of increasing the difficulty in cutting through the catalytic converter shield 130 as well as facilitating an alarm event being initiated by the alarm device 276 in response the sensor 274 detecting that the tensile wires 256 have been cut.

From the above, it is to be appreciated that defined herein is a catalytic converter shield for protecting a catalytic converter on a vehicle from theft activity. The catalytic converter includes a wire array provided between a first panel and a second panel. The wire array may include one or more tensile wires to increase difficulty and noise while attempting to cut through the catalytic converter shield and/or one or more electrical wires in electrical communication with a sensor to detect when the catalytic converter shield is being cut. In response to the sensor detecting that the electrical wires have been cut, the sensor sends a signal to an alarm device of the vehicle to initiate an alarm event to deter the theft activity.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A catalytic converter shield assembly comprising:
a catalytic converter shield comprising:
a first panel having an inner surface and an opposite outer surface;
a second panel having an inner surface facing the first panel and an opposite outer surface;
a wire array provided between the first panel and the second panel; and
a heat shielding layer provided on the outer surface of the first panel opposite the wire array.

2. The catalytic converter shield assembly of claim 1, further comprising a substrate layer provided between the first panel and the second panel, the wire array embedded within the substrate layer.

3. The catalytic converter shield assembly of claim 1, wherein the wire array comprises a wire mesh.

4. The catalytic converter shield assembly of claim 3, wherein the wire mesh has a hardness of at least 1,000 megapascals (MPa).

5. The catalytic converter shield assembly of claim 1, wherein the wire array comprises one or more electrical wires communicatively coupled to an alarm device of a vehicle.

6. The catalytic converter shield assembly of claim 5, further comprising:
a sensor communicatively coupled between the one or more electrical wires and the alarm device of the vehicle,
wherein the sensor is configured to send a signal to the alarm device to initiate an alarm event in response to detecting a discontinuity in the one or more electrical wires.

7. The catalytic converter shield assembly of claim 1, wherein the wire array comprises:
a wire mesh; and
one or more electrical wires communicatively coupled to an alarm device of a vehicle.

8. The catalytic converter shield assembly of claim 1, wherein the first panel and the second panel are each spray transfer molded layers including fiberglass.

9. The catalytic converter shield assembly of claim 1, wherein the catalytic converter shield comprises:
a plurality of mounting pockets, each mounting pocket including a reinforcing plate defining a plate opening; and
a plurality of mounting clips, each mounting clip including a body, a first engaging portion provided at a first end of the body, and a second engaging portion provided at a second end of the body opposite the first end.

10. A vehicle comprising:
a chassis;
an exhaust pipe having an upstream portion and an opposite downstream portion;
a catalytic converter interposed between the upstream portion and the downstream portion of the exhaust pipe; and
a catalytic converter shield assembly coupled to the chassis, the catalytic converter comprising:
a catalytic converter shield provided on a side of the catalytic converter opposite the chassis, the catalytic converter shield comprising:
a first panel having an inner surface and an opposite outer surface;
a second panel having an inner surface facing the first panel and an opposite outer surface;
a wire array provided between the first panel and the second panel; and
a heat shielding layer provided on the outer surface of the first panel opposite the wire array.

11. The vehicle of claim 10, wherein the heat shielding layer faces the catalytic converter.

12. The vehicle of claim 10, wherein the wire array comprises a wire mesh.

13. The vehicle of claim 12, wherein the wire mesh has a hardness of at least 1,000 MPa.

14. The vehicle of claim 10, further comprising:
an alarm device; and
a sensor communicatively coupled to the alarm device,
wherein the wire array comprises one or more electrical wires communicatively coupled to the sensor,
wherein the sensor configured to send a signal to the alarm device to initiate an alarm event in response to detecting a discontinuity in the one or more electrical wires.

15. The vehicle of claim 10, wherein the first panel and the second panel are each spray transfer molded layers including fiberglass.

16. The vehicle of claim 10, wherein a plurality of pocket openings are formed in the catalytic converter shield and a reinforcing plate surrounds each of the plurality of pocket openings.

17. A method comprising:
positioning a wire array between a first spray transfer molded panel and a second spray transfer molded panel;
positioning a heat shield layer to an outer surface of the first spray transfer molded panel opposite the first spray transfer molded panel; and
molding the first spray transfer molded panel, the wire array, the second spray transfer molded panel, and the heat shield layer to form a catalytic converter shield.

18. The method of claim 17, wherein the wire array comprises one or more electrical wires, the method further comprising:
electrically coupling the one or more electrical wires to a sensor configured to send a signal to an alarm device to initiate an alarm event in response to the sensor detecting a discontinuity in the one or more electrical wires.

19. The method of claim 17, further comprising:
forming a plurality of pocket openings in the catalytic converter shield; and
providing a reinforcing plate between the first spray transfer molded panel and the second spray transfer molded panel to surround each of the plurality of pocket openings.

20. The method of claim 19, further comprising:
providing a plurality of mounting clips on an outer surface of the second spray transfer molded panel, the plurality of mounting clips securing the catalytic converter shield onto a chassis of a vehicle, the plurality of mounting clips spaced apart from the plurality of pocket openings.
